(19) United States
(12) Patent Application Publication
(10) Pub. No.: US 2003/0146524 A1
(43) Pub. Date: Aug. 7, 2003

(54) Plastic random packing element

(76) Inventor: Hassan S. Niknafs, Stow, OH (US)

Correspondence Address: David Bennett, Saint-Gobain Corporation, 1 New Bond Street, Worcester, MA, 01606, US

(21) Appl. No.: 10/068,485

(22) Filed: Feb. 5, 2002

(51) Int. Cl. B01F 3/04

(52) U.S. Cl. 261/94; 261/DIG. 72

(57) ABSTRACT

The invention provides a novel improved plastic packing element having the basic shape of a polygon with arches formed around the periphery by deforming the edge area in one direction and an area axially within the edge area to form arches projecting in the opposite direction and providing an axially located aperture. Such packing elements can be conveniently formed using a simple cutting and stamping operation or, more preferably, by an injection molding process.

### BACKGROUND OF THE INVENTION

This invention relates to plastic packing elements of the type that are often called “random” or “dumped” packings. Such packings are used to fill towers units in which mass or heat transfer processes occur. The objective of the packings is to provide maximum effective contact between fluids flowing in the tower. Maximum efficiency is achieved when liquid flows down the tower in thin films or small droplets rather than in streams. Another key factor in maximizing efficiency is the maintenance of as low a pressure difference between top and bottom of the tower as possible. To ensure this the packing elements should present the minimum resistance to flow. This is promoted by very open structures but open structure alone is of limited use if the elements in the tower nest together such that parts of one packing element penetrate within the space of a second element. It is therefore important that the design of the elements minimize the tendency of the elements to nest together.

A novel design for a packing element has now been found that provides greater than 95% of open space within the element and still resists nesting of the elements which reduces the open space and promotes uniform flow and turbulent mixing of fluids within a tower filled with the packings.

The design has the advantage that the packing can, if desired, be molded from a flat plastic sheet or injection-molded in a simple operation to produce a very open shape that resists crushing and nesting.

### DESCRIPTION OF THE INVENTION

The present invention provides a plastic packing element in the form of a basic plastic sheet located in a first plane and having the form of a polygon with 3 to 6 corners from which a first group of spaced peripheral strips between each pair of adjacent corners of the sheet are deformed in a first direction to form a first set of arched structures with the apices of at least some of the arches in a second plane parallel to the first plane and removed therefrom in the first direction, a second group of strips equal in number and parallel to the corresponding strips in the first group but each being displaced radially inwardly from the corresponding strip from the first group, each strip being deformed out of the first plane in a second direction which is generally opposite to the first direction to form a second set of arched structures with the apices at least some of the arches in a third plane parallel to the first plane, and an axially central aperture formed in the sheet and defined by a generally circular periphery and an axially-located rod connected to the periphery by a plurality of radial struts.

Both sets of arches can be described as extending generally above or below the first plane but the plane of each arch need not be perpendicular to the first plane and indeed it is often preferred that this is not so. For this reason the direction of deformation of the inner set of strips to form the secon set of arched structures is described as being “generally opposite” from the first direction in which the outer set of strips were deformed to form the first set of arched structures. This is intended however only to require that the apices of the two groups of arches lie on different sides of the first plane.

The basic sheet upon which the packing element is constructed is preferably axially symmetrical with sides of equal length. The preferred number of equal length sides is three.

In a preferred structure the lengths of each of the second group of parallel strips from which the second set of arched structures are formed are shorter than the corresponding adjacent strips from the first group of strips. Thus the arched structures formed from the second set of strips are preferably smaller than those formed from the first set of strips. It is also preferred that the arched structures within each group be substantially the same size such the apices of all arched structures within a group lie in the same plane parallel to and displaced from the first plane.

The axially located aperture is defined by a periphery and is preferably provided with tongue members which project from the periphery in the first direction.

Apertures defined by a generally circular periphery are also preferably located adjacent at least some of the corners of the polygonal sheet. These also are provided with tongues dependent in the first direction from the periphery of the corner apertures.

The tongues depending in the first direction from the periphery of both the axial and corner apertures preferably have the shape of triangles and most preferably the triangles are equilateral or have two equal sides with the shortest side at the periphery of the aperture.

The tongues not only provide excellent means of breaking up stream flows into a series of drips but they also generate turbulence in gas flows passing therethrough, so enhancing the efficiency of the contact between counterflowing fluids.

The shapes described herein are particularly effective because they have greater than 95% internal open space ensuring a very low pressure drop while at the same time resisting nesting and deformation under pressure.

The invention further comprises a process for the production of a packing element according to the invention which comprises providing a polygonal plastic sheet having from 3 to 6 corners and symmetrical about an axis perpendicular to the sheet:

a) incising a first group of cut lines, each of which is adjacent to, parallel to and equidistant from one of the sides of the sheet to form a first group of strips between each pair of adjacent corners of the sheet and each located between an edge of the sheet and a cut line;

b) incising a second group of cut lines, each line being adjacent to, parallel to, and equidistant from one of the lines of the first group of cut lines to form a second group of strips parallel to the first;

c) incising a group of cut lines of equal length radiating from the axis of the sheet;

and then applying pressure to the sheet to deform the sides of the sheet between the edges and the first cut lines in a first direction to form a first set of arched structures; deforming the strips between the first and second cut lines in a generally diametrically opposite direction to said first direction to form a second set of arched structures, and bending the portions of the sheet between adjacent lines of those cut radially from the axis of the sheet so as to form a plurality of dependent tongues projecting in the first direction from the periphery of an aperture in the sheet.

In a preferred process each of the corners of the polygonal sheet is provided with a pattern of cut lines of equal length radiating from a point adjacent each corner and the portions of the sheet between adjacent radial cut lines is bent in the first direction such that an aperture is formed with a circle of triangular tongues depending in the first direction from the periphery of the aperture.

In a further preferred process the plastic packing according to the invention is made by an injection molding process. Packing elements made by such a process are preferably provided with strengthening ribs that would not be readily provided if the element were to be made by deformation from a flat sheet as described above. Thus it is particularly preferred that the arched structures extending between the same pairs of corners of the sheet are connected by a plurality of parallel ribs. A further preferred feature of injection molded packing elements is a network of ribs connecting the periphery of the central aperture with the corners of the sheet and with the arched structures.

### DRAWINGS

FIG. 1 is a perspective view of a packing element of the invention from a point below and to one side, looking directly at one of the corners of the triangular element.

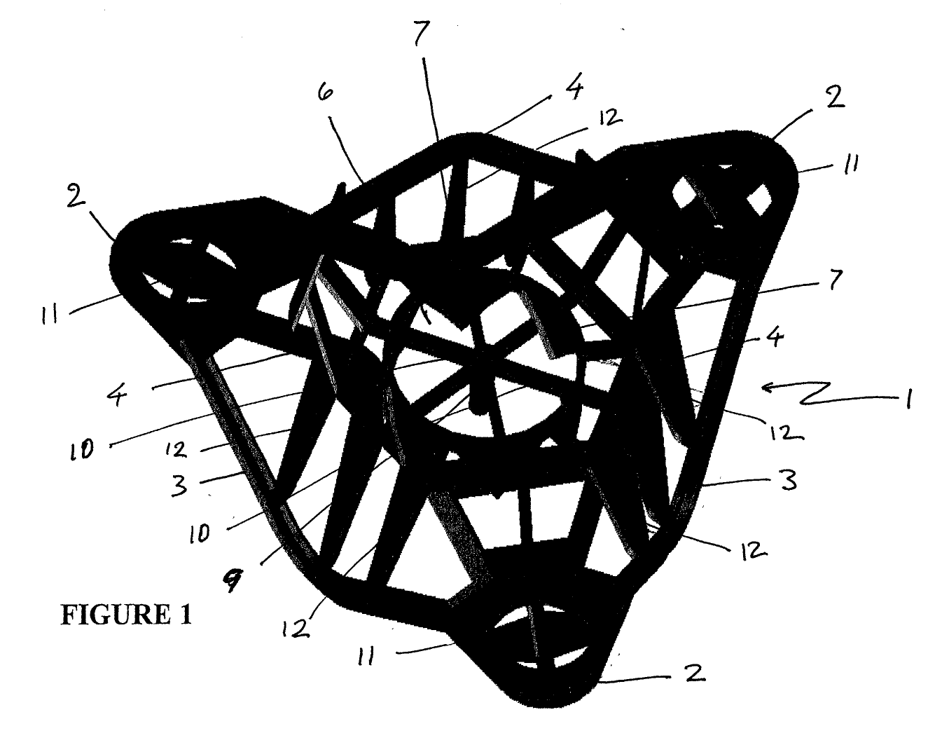

FIG. 2 shows the same element as is shown in FIG. 1 from the side, this time looking directly at the mid-point of one of the sides of the element.

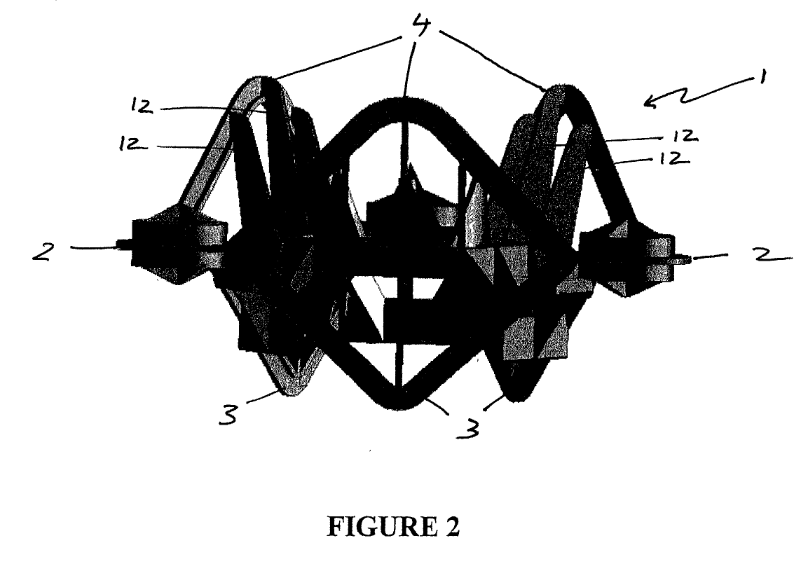

FIG. 3 is a view looking down on the element depicted in FIGS. 1 and 2.

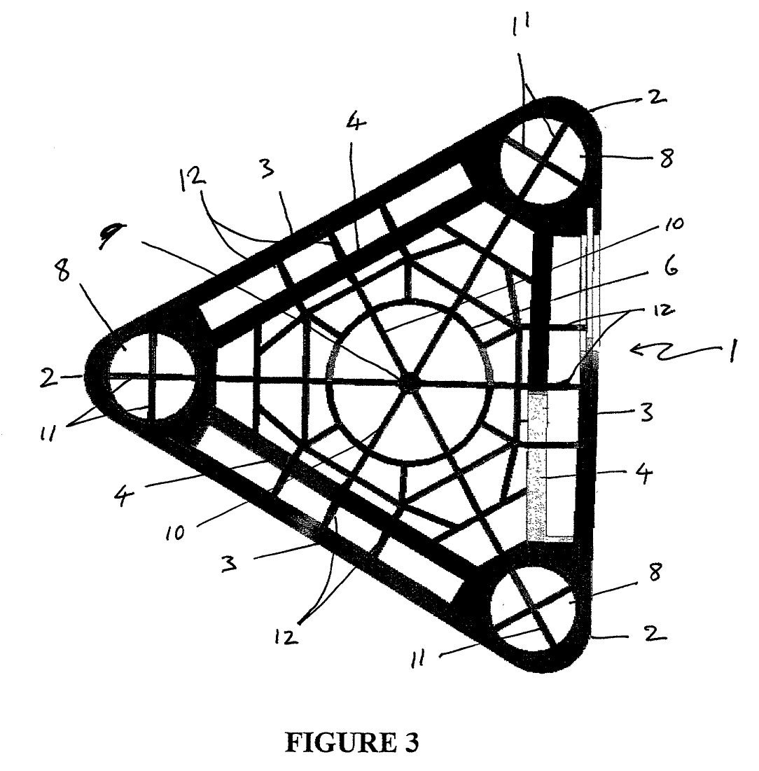

### DESCRIPTION OF PREFERRED EMBODIMENT

The invention is now more particularly described with reference to the embodiment illustrated in the Drawings. This is not intended to imply any necessary limitations in the scope of the invention because it will be readily appreciated that many minor variations could be made without departing from the essential spirit of the invention.

The Drawings show a triangular packing element, 1, with three corners, 2. Along each of the three edges of the sheet first arched structures, 3, extend generally downwards, each structure being of essentially the same dimensions. Located inwardly of the set of first arched structures, 3, is a second set of arched structures, 4, formed in a direction that is generally diametrically opposite to that of the first set of arched structures. The axially central portion of the element is provided with a generally circular aperture, 6, from the periphery of which tongues, 7 depend in the first direction. Circular apertures, 8, are provided adjacent each of the corners of the element, each being provided with septa, 11, extending across diameters of the aperture.

The apices of each of the arched structures in each group lie in the same plane, though it is noted that the structures extending in the second direction are smaller than those extending in the first direction.

Axially located in the center of the central aperture is a rod, 9, from which radially extending ribs, 10, connect the rod to the periphery of the aperture, the corners of the element, and to the mid-points of parallel connecting struts, 12, extending between each pair of first and second arched structures between adjacent corners of the element.

What is claimed is:

1. A plastic packing element in the form of a basic plastic sheet located in a first plane and having the form of a polygon with 3 to 6 corners and comprising: a first group of spaced peripheral strips between each pair of adjacent corners of the sheet extend in a first direction to form a first set of arched structures with the apices of at least some of the arches in a second plane parallel to the first plane and removed therefrom in the first direction; a second group of strips equal in number and parallel to the corresponding strips in the first group but each being displaced radially inwardly from the corresponding strip from the first group, each such strip extending in a second direction which is generally opposite to the first direction to form a second set of arched structures with the apices at least some of the structures in a third plane parallel to the first plane; and an axially central aperture formed in the sheet and defined by a generally circular periphery with an axially-located rod connected to the periphery by a plurality of radial struts.

2. A packing element according to claim 1 in which the polygon is an equilateral triangle.

3. A packing element according to claim 1 in which the arched structures in the second group are each smaller than the corresponding adjacent arched structure of the first group.

4. A packing element according to claim 1 in which the axially central aperture is defined by a periphery and pendant from said periphery in said first direction are a plurality of tongues.

5. A packing element according to claim 1 in which apertures are provided adjacent at least some of the corners of the sheet each aperture being defined by a periphery and having a plurality of tongues pendant from the periphery in the first direction.

6. A packing element according to claim 1 in which the first and second arched structures in each adjacent pair are connected by a plurality of parallel ribs.

7. A packing element according to claim 1 in which the axially located rod is connected by radially extending struts to the corners of the element.

8. A packing element according to claim 7 in which the radially extending struts also connect the rod to ribs connecting first and second sets of arched structures in each adjacent pair of such structures.

9. A packing element according to claim 5 in which the apertures located at the corners of the element are provided with a plurality of radial bracing septa.

10. A packing element according to claim 1 made by a process which comprises:
a) providing a polygonal sheet with from 3 to 6 corners and symmetrical about an axis perpendicular to the sheet:
b) incising a first group of cut lines, each of which is adjacent to, parallel to and equidistant from one of the sides of the sheet to form a first group of strips each located between an edge of the sheet and a cut line;
c) incising a second group of cut lines, each line being adjacent to, parallel to, and equidistant from one of the lines of the first group of cut lines to form a second group of strips parallel to the first;
d) incising a group of cut lines of equal length radiating from the axis of the sheet;
e) and then applying pressure to the sheet to deform the sides of the sheet between the edges and the first cut lines in a first direction to form arches; deforming the strips between the first and second cut lines in a diametrically opposite direction to said first direction to form arches, and bending the portions of the sheet between adjacent lines of those cut radially from the axis of the sheet so as to form a plurality of dependent tongues projecting in the first direction from the periphery of an aperture in the sheet.

11. A packing element according to claim 1 in which the element is made by an injection molding process.

12. A packing element according to claim 1 made from a thermoplastic material.

13. A packing element according to claim 12 in which the thermoplastic material is selected from the group consisting of polyols, halogenated polyolefins, polyesters and polyamides.
